(19) United States
(12) Patent Application Publication
(10) Pub. No.: US 2004/0050757 A1
(43) Pub. Date: Mar. 18, 2004

(54) Multi-deck screening machine

(75) Inventor: Franz Anibas, Gleisdorf (AT)

Correspondence Address: Kurt Kelman, COLLARD & ROE, P.C., 1077 Northern Boulevard, Roslyn, NY, 11576, US

(73) Assignee: Binder + Co. AG

(21) Appl. No.: 10/652,548

(22) Filed: Aug. 29, 2003

(30) Foreign Application Priority Data
Sep. 12, 2002 (AT) GM 606/2002

(51) Int. Cl. B07B 1/28; B07B 1/49

(52) U.S. Cl. 209/309; 209/399; 209/405

(57) ABSTRACT

A screening machine with a screen frame (1) which can be made to oscillate by means of a drive, comprises screen cheeks and is supported in an elastic manner on a solid base, preferably by means of springs (4), and a swing frame which is elastically coupled thereto and comprises thrust rods (5) elastically coupled to the screen cheeks as well as swing frame crossbeams (7) which connect the same and a screening surface (9, 10) which is formed by screening mats (11), with the screening mats (11) being alternatingly compressed and stretched at least in sections by alternating fastening to the screen frame (1) and to the swing frame. In order to provide a multi-deck screening machine which avoids these disadvantages, results in a compact size and still offers the advantages of the more selective fractioning, it is provided that in addition at least one further screening surface (9, 10) is provided which is formed by screening mats (11) and all available screening mats (11) are fastened in an alternating manner to the screen frame (1), preferably to the screen frame crossbeams (12) which connect the screen cheeks, and to the swing frame, preferably to the swing frame crossbeams (7).

The present invention relates to a screening machine according to the preamble of claim 1.

Screening machines with a screening surface made up of screening mats are known from AT 379.088 for example. The movement of the screening mats usually occurs by a amplitude-excited oscillation system which is held on a moved screen frame. The screening mats forming the screening surface are fastened alternatingly on the screen frame and the oscillation system, so that there will be a compression or stretching of the screening mats through the relative movement of the two systems with respect to each other.

In order to obtain several fractions for example it is also known to provide two such amplitude-excited oscillation systems independent from each other in an oscillating screen frame.

This leads to the disadvantage that such a two-deck screening machine is very high with respect to its design and therefore cannot be used everywhere. Moreover, the constructional efforts for two oscillation systems are very high and an adjustment needs to be made for each oscillation system separately. The construction of multi-deck (>2) oscillation systems is therefore out of the question in view of these configurations.

It is therefore the object of the present invention to provide a screening machine which avoids these disadvantages, is of a compact design and still offers the advantages of a more selective fractioning of two-deck screening machine.

This is achieved in accordance with the invention by the characterizing features of claim 1.

It is thus merely necessary to arrange a single oscillation system on the screen frame in which the screening mats are fixed in addition to the fixing on the screen frame.

The entire screening machine is thus provided with a substantially lower design despite the fact that several screen surfaces which are formed by screening mats are available. The application as a mobile screening unit is thus also possible. The configuration of two or more screening surfaces can thus be realized easily.

The characterizing features of claim 2 allow the further conveyance of the material to be screened in the direction of inclination.

The characterizing features of claims 3 to 5 describe a preferred embodiment of the fastening of the screen frame crossbeams on the oscillation system. This allows providing several screen surfaces on one and the same oscillation system.

The different geometrical arrangement of the fixing points of the screen frame crossbeams on the fastening components according to claims 6 and 7 is made on the basis of experimental values with respect to the respective material to be screened and leads to an increase in the screening effect.

The characterizing features of claims 8 and 9 describe a preferred possibility for arranging the screen surfaces which achieves the best screening effect in practice.

A detailed description of the invention on the basis of an embodiment is provided below by reference to the enclosed drawings, wherein:

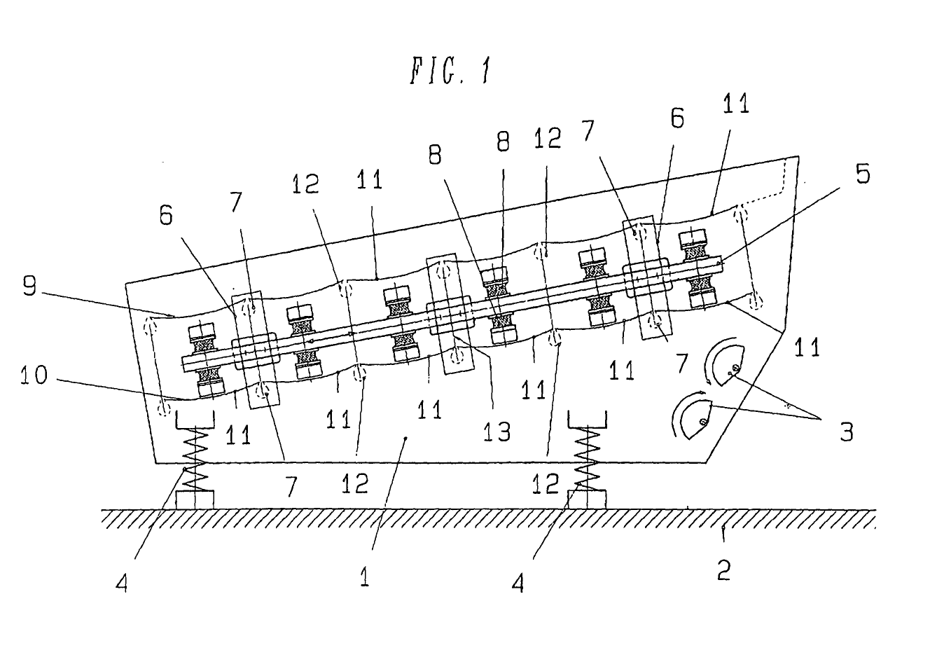

FIG. 1 shows a schematic side view of a screening apparatus in accordance with the invention;

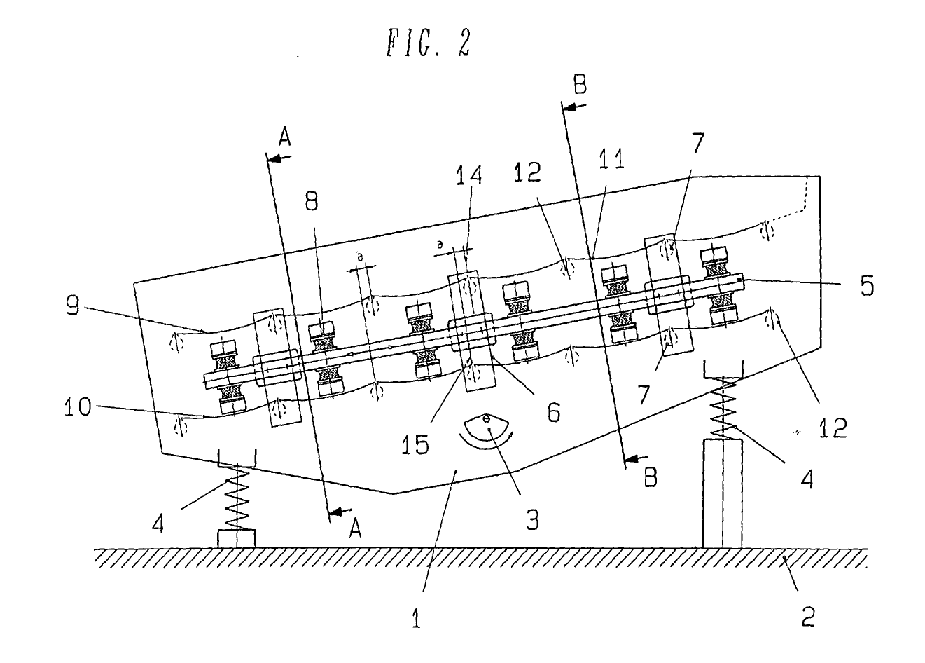

FIG. 2 shows a schematic side view of an alternative embodiment of a screening apparatus in accordance with the invention;

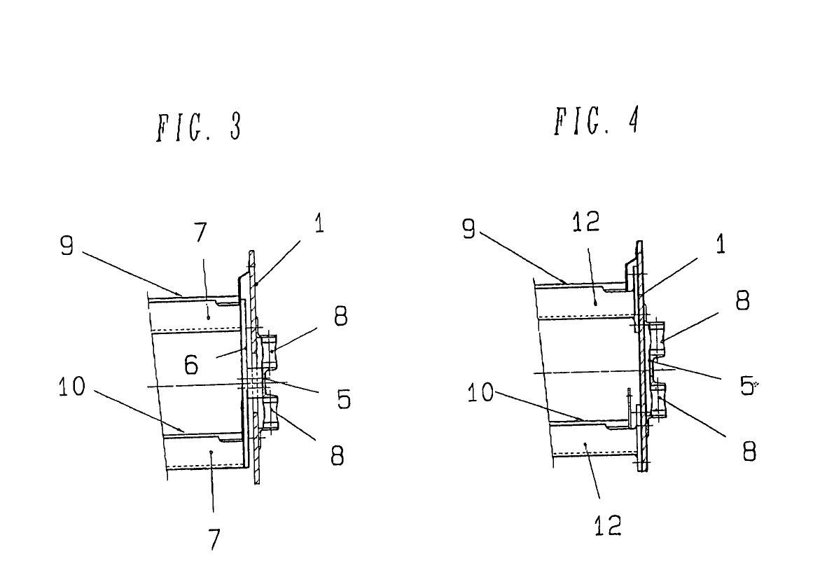

FIG. 3 shows a sectional view along line AA of FIG. 2;

FIG. 4 shows a sectional view along line BB of FIG. 2;

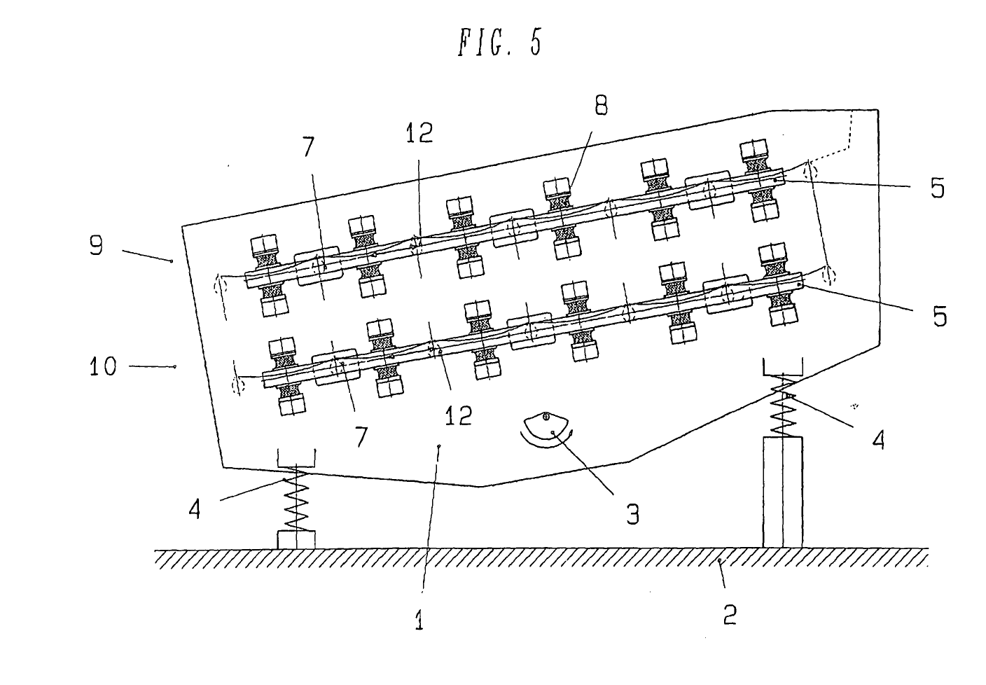

FIG. 5 shows a schematic side view of a multi-deck screening machine according to the state of the art;

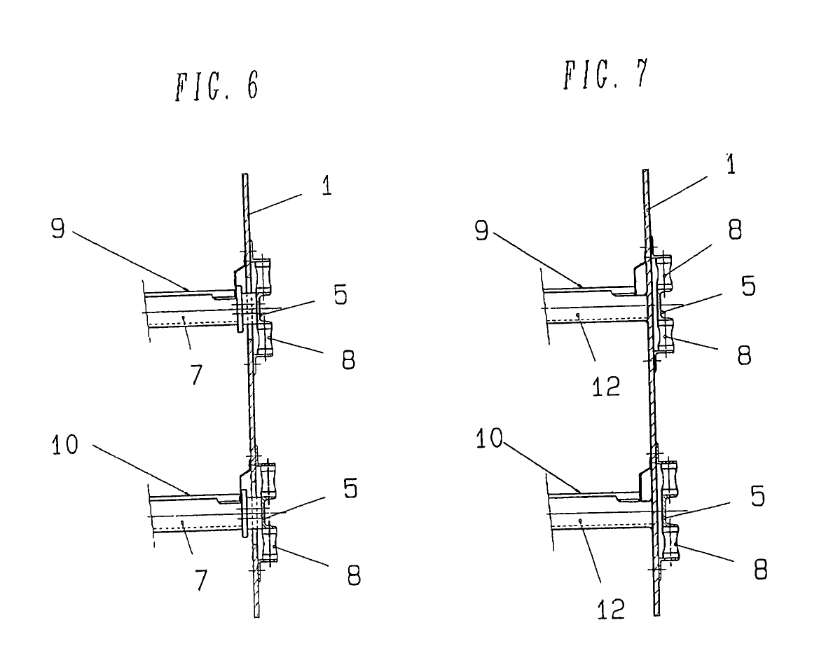

FIG. 6 shows a side view along line CC of FIG. 5;

FIG. 7 shows a side view along line DD of FIG. 5.

As is shown in FIG. 1, a two- or multi-deck screening machine in accordance with the invention consists of a screen frame 1 which comprises screen cheeks and is supported on springs 4 relative to a fixed base 2 and of a drive 3 which makes the screen frame 1 oscillate. In the present case it is configured as a double unbalance-type drive with two oppositely rotating unbalance weights, as a result of which a linear excitation oscillation is produced. Principally, however, all kinds of unbalance drives can be used. FIG. 2 shows the use of a single unbalance drive 3 for example which makes the screen frame oscillate in a circulatory fashion.

An oscillation system is arranged on the screen frame 1 which forms a swing frame, which oscillation system consists of thrust rods 5 which are held on the screen cheeks of the screen frame 1 via preferably elastic rubber blocks 8 as well as fastening components 6 which are arranged on the same. The fastening components 6 extend in a substantially rectangular manner to the longitudinal axis of the thrust rods 5 and parallel to the screen cheeks of the screen frame 1. Two swing frame crossbeams 7 are fastened below each other to the fastening components 6. The swing frame crossbeams mutually connected oppositely disposed fastening components 6.

The screen cheeks of the screen frame 1 are mutually connected via screen frame crossbeams 12.

The screen surfaces 9, 10 are made up of individual screening mats 11. Every screening mat 11 is fastened in an alternating manner to a swing frame crossbeam 7 and a screen frame crossbeam 12.

The fastening of the swing frame crossbeam 7 and the screen frame crossbeam 12 of a screening surface 9, 10 occurs substantially along a straight line, so that a continuous, substantially straight screening surface 9, 10 is obtained. Any deviations from a straight screening surface 9, 10 are obtained through the system due to a certain sagging of the individual screening mats. This is necessary in order to allow the compression and stretching of the screening mats 11.

The screening apparatus works in the following manner: The swing frame is also made to oscillate in an amplitude-excited fashion by the screen frame 1 which is made to oscillate by the unbalance drive 3. As a result of the elastic bearing of the thrust rods 5 of the swing frame on the screen frame 1, an oscillation of the swing frame is obtained which is offset to the fundamental oscillation of the screen frame 1. As a result of the alternating fastening of the screening mats 11 on the screen frame 1 and on the swing frame (fastening components 6), the screening mats 11 are alternatingly compressed and stretched. This on the other hand produces an optimal screening effect.

The screening apparatus in accordance with the invention is especially characterized in that it is of a two- or multi-deck arrangement and still merely one oscillation system is present. This leads to the advantage that the entire apparatus is provided with a low overall height, thus allowing mobile applications. Moreover, the adjustment of the oscillation systems is substantially easier because it is merely necessary to adjust one system. In the case of a multi-deck arrangement it is necessary to arrange several respective swing frame crossbeams 7 on the respective fastening components 6.

For reasons of clarity, the present embodiment only includes two screening decks, i.e. screening surfaces 9, 10. It is obvious, however, that a random number of screening surfaces can be provided in an arrangement above one another.

In order to further increase the screening output, it is provided that the fixing of the individual oscillation system crossbeams 7 which are arranged on a fastening component 6 is made in at least two planes 14, 15 which extend in a normal manner to the longitudinal axis of the thrust rods 5. An offset “a” is obtained which is based on the batch material supplied to the screening machine and the separating cut sizes.

It is also possible to provide the fixing of the individual oscillation system crossbeams 7 which are arranged on a fastening component 6 in a single plane (13) which extends in a normal manner to the longitudinal axis of the thrust rods (5).

The screen frame crossbeams 12 of the individual screening surfaces 9, 10 can either each be arranged in a plane which is normal to the longitudinal axis of the thrust rods 5 or with an offset “a” (see FIG. 2).

The present oscillation system can also be provided with a banana arrangement with a continuously decreasing screen deck inclination.

1. A screening machine with a screen frame (1) which can be made to oscillate by means of a drive, comprises screen cheeks and is supported in an elastic manner on a solid base (2), preferably by means of springs (4), and a swing frame which is elastically coupled thereto and comprises thrust rods (5) elastically coupled to the screen cheeks as well as swing frame crossbeams (7) which connect the same and a screening surface (9, 10) which is formed by screening mats (11), with the screening mats (11) being alternatingly compressed and stretched in sections by alternating fastening to the screen frame (1) and to the swing frame, characterized in that in addition at least one further screening surface (9, 10) is provided which is formed by screening mats (11) and all available screening mats (11) are fastened in an alternating manner to the screen frame (1), preferably to the screen frame crossbeams (12) which connect the screen cheeks, and to the swing frame, preferably to the swing frame crossbeams (7).

2. A screening machine as claimed in claim 1, characterized in that the thrust rods (5) extend at an angle or at an angle decreasing in the conveying direction inclined to the fixed base (2).

3. A screening machine as claimed in claim 1 or 2, characterized in that fastening parts (6) are provided on the swing frame, preferably on the thrust rods (5), which are used for fixing the swing frame crossbeams (7) on the swing frame.

4. A screening machine as claimed in claim 3, characterized in that several swing frame crossbeams (7) are fixed to a fastening component (6).

5. A screening machine as claimed in one of the claims 1 to 4, characterized in that the fastening components (6) projecting substantially in a rectangular manner, preferably on both sides from the thrust rods (5) and parallel to the screen cheeks.

6. A screening machine as claimed in one of the claims 1 to 5, characterized in that the fixing points of the swing frame crossbeams (7) lie on the respective fastening component (6) in a plane (13) extending in a normal manner to the longitudinal axis of the thrust rods (5).

7. A screening machine as claimed in one of the claims 1 to 6, characterized in that the fixing points of the swing frame crossbeams (7) lie on the respective fastening component (6) in at least two planes (14, 15) extending in a normal manner to the longitudinal axis of the thrust rods (5).

8. A screening machine as claimed in one of the claims 1 to 7, characterized in that the screening surfaces (9, 10) which are formed by the screening mats (11) extend in a substantially parallel manner with respect to each other.

9. A screening machine as claimed in one of the claims 1 to 8, characterized in that the swing frame crossbeams (7) are arranged on each fastening component (6) on either side of the respective thrust rods (5).
